(19) United States
(12) Patent Application Publication
(10) Pub. No.: US 2011/0161463 A1
(43) Pub. Date: Jun. 30, 2011

(54) Electronic Citation Recording, Processing and Storing

(76) Inventor: Jeremy Keith MATTERN, Houston, TX (US)

(21) Appl. No.: 12/648,850

(22) Filed: Dec. 29, 2009

(51) Int. Cl. G06F 15/16

(52) U.S. Cl. 709/219

(57) ABSTRACT

A method is disclosed for tracking citations data using a server. Specifically, a citation record is received by a server from a mobile citation device, a citation history is transmitted from the server to a computer, a citation disposition record related to the citation record by is received the server, and the citation record and the citation disposition record is stored in a storage device.

### BACKGROUND

This disclosure relates to a system and method for electronic citation and citation adjudication. More particularly, this disclosure relates to populating an electronic citation, and delivering the citation for disposition.

For violations of codes, authorities can issue citations to alleged offenders. For example, a civilian police officer might issue a citation to a motorist if the officer sees the motorist failing to stop at a stop sign. In the military similar citations may be issued. As an example, A DD Form 1408 (Armed Forces Traffic Ticket) is a citation issued for minor infractions such as talking on a cellular phone while driving, speeding or failing to stop at a stop sign. Commanders and Civilian Supervisors (hereinafter referred to as “Supervisor”) are the deciding authority on DD Form 1408, not a Federal Magistrate. Once the Supervisor has rendered a decision, the commanding officer communicates his decision with record keeping personnel for record keeping and enforcement. Penalties from DD 1408 are assessed by supervisor, which can include traffic points, suspended driving privileges, among other things as determined by the Supervisor.

Present ticketing methods include officers stopping violators and filling out violation information on a carbon paper citation. One copy of the paper citation is delivered to the violator's supervisor, a second copy is given to the violator, and a third copy is kept by the officer to give to the record keeping personnel. The supervisor can then review the citation, and after making proper notations on the citations regarding the manner the dispositions, can deliver the copy to the record keeping personnel.

However there are a number of problems associated with paper citations. First, officer handwriting can often be illegible. Second, carbon copies are often difficult to read if the officer does not write with sufficient force. Third, paper copies can be lost, either in delivery or by the recipient. Finally, if the paper citations are eventually keyed into an electronic database, clerical errors can be made. It would therefore be advantageous to implement a method and system for electronically creating, processing, and storing citations

### SUMMARY

A method is disclosed for tracking citations data using a server. Specifically, a citation record is received by a server from a mobile citation device. A citation history is transmitted from the server to a computer, a citation disposition record related to the citation record by is received the server. The citation record and the citation disposition record are then stored in a storage device.

Further, a server is disclosed. Specifically, the server receives a first citation record from a mobile citation device, transmits a citation history to a computer, receives a citation disposition record related to the first citation record by the server; and stores the first citation record and the citation disposition record in a storage device.

A citation management system is disclosed. Specifically the system comprises a mobile citation device and a server. The server receives a citation record from a mobile citation device, transmits a notification to a third party, receives a response from the third party, and stores the first citation record and the citation disposition record in a storage device.

### BRIEF DESCRIPTION OF THE DRAWINGS

FIG. 1 illustrates a citation management system.

FIG. 2A illustrates input and output hardware on a mobile citation device.

FIG. 2B illustrates internal hardware within a mobile citation device.

FIG. 3 illustrates a touch screen operable by a stylus.

FIG. 4 illustrates a unique identifier stored in a citation record.

FIG. 5 illustrates data flow during citation recording, processing and storing.

FIG. 6 illustrates an exemplary method of tracking citation data.

### DETAILED DESCRIPTION

Described herein is a method for creating, processing and storing an electronic citation. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), numerous programming decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of database design and management having the benefit of this disclosure. Accordingly, the claims appended hereto are not intended to be limited by the disclosed embodiments, but are to be accorded their widest scope consistent with the principles and features disclosed herein.

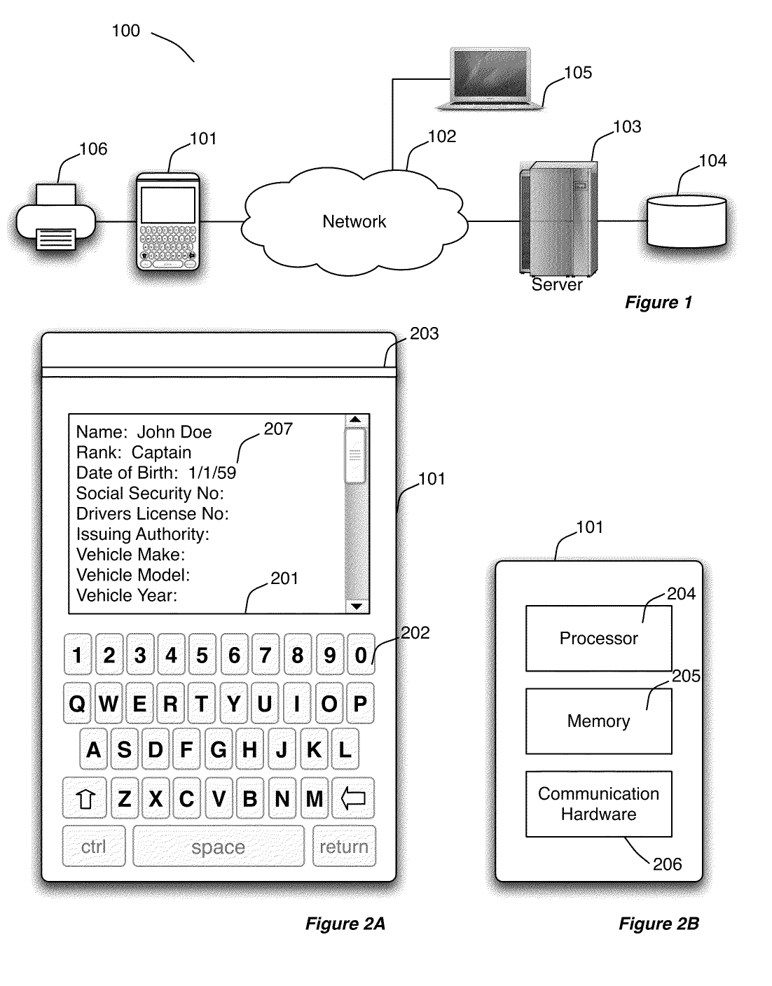

FIG. 1 illustrates a citation management system 100 comprising a mobile citation device 101 that can capture citation data at or near the location of a violation. Mobile citation device 101 connects to a printer 106 and a network 102, which can connect to at least one server 103. In one embodiment, as shown in FIG. 1, printer 106 can be hardwired to mobile citation device 101. In another embodiment, printer 106 can connect to mobile citation device via a localized network, such as a piconet. In another embodiment, printer 106 is a component of Network 102 can be a local area network (LAN), a wide area network (WAN), a piconet, or a combination of LANs, WANs or piconets. One illustrative LAN is a network within a single business. One illustrative WAN is the Internet. Server 103 represents at least one, but can be many servers, each connected to network 102. Server 103 can connect to a storage device 104. Storage device 104 can connect directly to server 103, as shown in FIG. 1, or may exist remotely on network 102. Storage device 104 can comprise any suitable long-term or persistent storage device and, further, may be separate devices or the same device and may be collocated or distributed (interconnected via any suitable communications network). Citation management system 100 can also include a computer 105, connected to the network. Computer 105 can include, but is not limited to, a laptop, desktop, workstation, server, mainframe and/or terminal.

FIGS. 2A and 2B illustrate mobile citation device 101. FIG. 2A illustrates input and output devices on mobile citation device 101. Mobile citation device 101 can include, but is not limited to, a screen 201, a keypad 202 and a card reader 203. Other input devices can include track balls, joy sticks, or scroll wheels. Screen 201 can be a mere display output, or may also be a touch screen, allowing for capture of input data 208. Input data can include a violator's name, military rank, serial number, grade, military organization, military installation, and/or an identity of a supervisor. Keypad 202 can comprise of a plurality of physical buttons on mobile citation device 101, however in an embodiment were screen 201 is a touch screen, keypad 202 can be represented virtually on screen 201. Card reader can read information from an identification card. An identification card can encode information in various ways. Information can be printed on the information card. Also, information can be placed on the card in a machine-readable form. Such forms can include magnetic strip, barcode or even radio frequency identification (RFID) chip. An identification card can include, but is not limited to, a civilian or military driver's license, a passport, a school identification badge or a credit card. In one embodiment, card reader 203 can read a magnetic strip on an identification card. In another embodiment, card reader 203 can read information encoded in a barcode on an identification card. In another embodiment card reader 203 comprises a (RFID) chip receiver to read an RFID chip in an identification card. FIG. 2B illustrates internal hardware within mobile citation device 101. Input data 207 from screen 201, keypad 202 and/or card reader 203 is sent to a processor 204. Processor 204 can perform processes on the data according an application stored in a memory 205, as discussed further below. Processes can include storing input data 207 to memory 205, verifying input data 207 conforms to preset standards or ensuring all required data has been gathered for a citation to be complete. For purposes of this disclosure input data 207 can include data which mobile citation device 101 may populate automatically, such as date and time, as well as data entered manually. Once a citation is complete, an on-site citation record can be sent to communication hardware 206 for communication over network 102. Communication hardware 206 can include a network transport processor for packetizing data, communication ports for wired communication or an antenna for wireless communication.

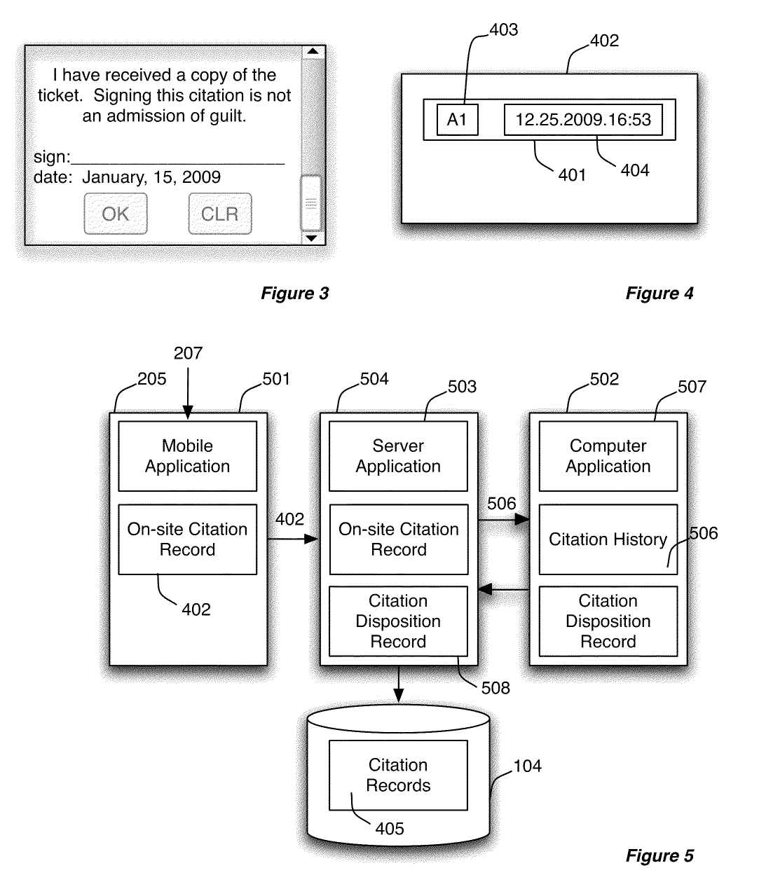

FIG. 3 illustrates a touch screen operable by stylus. In some jurisdictions, it may be necessary to obtain a signature from a violator. In one embodiment, screen 201 can be used as an input device using a stylus. Using the stylus, a violator can sign his name on screen 201. Screen 201 can then capture the signature as an image to store with other citation data.

FIG. 4 illustrates a unique identifier 401 in an on-site citation record 402. Mobile citation device 101 can record many on-site citation records similar to on-site citation record 402. Additionally citation management system 100 can comprise many mobile citation devices similar to mobile citation device 101. As such, it becomes necessary to distinguish one citation from a second citation. In one embodiment, mobile citation device 101 assigns unique identifier 401 to distinguish one citation from another citation, and includes unique identifier 401 as a portion of on-site citation record 402. Unique identifier 401 can be a string, or combination of strings, of letters numbers and/or symbols. Unique identifier 401 can be generated by mobile citation device 201. In one embodiment, mobile citation device 101 can be assigned a unique device identifier 403. Device identifier 403 can be used as at least a portion of unique identifier 401, as shown in FIG. 4. Further, in one embodiment, a portion of citation record 402 collected at the scene of the violation can be used as the unique identifier. As an example, a citation date and/or citation time can be used as unique identifier 401, as shown in FIG. 4 wherein the citation was given on Dec. 25, 2009 at 4:53 pm. In another embodiment, at least portion of unique identifier 401 can be a counter that increments with each citation. In instances where unique identifier is comprised of multiple strings, it is not necessary that the strings be stored together, but may be stored independently.

FIG. 5 illustrates data flow during citation recording, processing and storing. A mobile citation device application 501 can execute within memory 205. Mobile citation device application 501 processes input data 207 to form on-site citation record 402, mentioned above, in memory 205. On-site citation record 402 is then sent to server 103 where a server application 503 existing in a server address space 504. Server application 403 can perform various tasks including verifying that on-site citation record 402 is complete and storing on-site citation record 402 as a portion of citation record 405 in storage device 104. Further, in one embodiment, server 103 can create unique identifier 401. In such embodiment, server 103 can communicate unique identifier 401 to mobile citation device.

Server application 503 can also notify a third party, such a Supervisor, that a violator has received a citation. In one embodiment, the notification is sent to an email account of the Supervisor. The Supervisor can retrieve a citation history 506 using a computer application 507 capable of executing within a computer address space 502 in computer 105. An example of computer application 507 includes a web browser. Citation history 506 can include at least a portion of citation record 505 including unique identifier 401 and can also include portions previous citation records related to the violator or data extrapolated from previous citation records. In another embodiment, server transmits citation history 506 in the notification.

In one embodiment, a person such as a Supervisor can review citation history 506 to decide an appropriate disposition of the present citation. As an example, a Supervisor might let a violator off with a warning. If a violator has had a previous warning, the Supervisor may assign points to the Violator's driving record. In any of these scenarios, a Supervisor can create a citation disposition record 502. In one embodiment, citation disposition record 502 is created using computer application 507. In another embodiment, a separate application creates citation disposition record 408, and computer application 507 transmits a response comprising citation disposition record 502 to server 103. In another embodiment, computer application 407 allows a user to create citation disposition record 502 on the server side without ever creating such record within computer 105. In each embodiment, unique identifier 401 associated with citation disposition record 502 is referenced within citation disposition record 502.

Upon receiving citation disposition record 502, server application 403 can perform various tasks including verifying that citation disposition record 502 is complete and storing citation disposition record 502 with corresponding on-site citation record 402 as a portion of citation record 405 in storage device 104. On-site citation record 402 and citation disposition record 408 are matched using the unique identifier.

FIG. 6 illustrates an exemplary method of tracking citation data. First, citation record 402 is received from mobile citation device 101. In one embodiment the citation record 402 can contain unique identifier 401. Then citation history 506 is transmitted to computer 105. Citation history 506 can contain a portion of citation record 402. Next citation disposition record 508 is received from computer 105. Additionally, citation record 402 and disposition record are stored in storage device 104.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. In addition, acts in accordance with FIG. 4 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable storage medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method of tracking citations data using a server, comprising:
receiving a citation record by a server from a mobile citation device;
transmitting a citation history from the server to a computer;
receiving a citation disposition record related to the citation record by the server; and
storing the citation record and the citation disposition record in a storage device.

2. The method of claim 1, wherein the mobile citation device stores a unique identifier in the citation record.

3. The method of claim 2, wherein the mobile citation device comprises a unique device identifier.

4. The method of claim 3, wherein the unique identifier comprises the unique device identifier.

5. The method of claim 2, wherein the unique identifier comprises input data.

6. The method of claim 5, wherein the input data comprises a date.

7. The method of claim 5, wherein the input data comprises a time.

8. The method of claim 2, wherein the unique identifier comprises multiple strings.

9. The method of claim 8, wherein the multiple strings are stored independently.

10. The method of claim 1, wherein the server stores a unique identifier in the citation record.

11. The method of claim 10, wherein the unique identifier comprises a counter.

12. The method of claim 2, wherein the citation record comprises at least one of the following: a military rank, an identity of a supervisor, a military organization or a military installation

13. A server that:
receives a first citation record from a mobile citation device;
transmit a citation history to a computer;
receives a citation disposition record related to the first citation record by the server; and
stores the first citation record and the citation disposition record in a storage device.

14. The server of claim 13, wherein the citation history comprises at least a portion of the first citation record.

15. The server of claim 13, wherein the citation history comprises at least portion of a second citation record related to a violator named on the first citation record.

16. The server of claim 13, wherein the citation history comprises data extrapolated from at least a second citation record related to a violator named on the second citation record.

17. The server of claim 16, wherein the data extrapolated from the at least second citation record includes total points accumulated by the violator.

18. A citation management system comprising:
a mobile citation device; and
a server that
receives a citation record from a mobile citation device;
transmits a notification to a third party
receives a response from the third party; and
stores the first citation record and the citation disposition record in a storage device.

19. The system of claim 18, wherein the notification comprises a citation history.

20. The system of claim 18, wherein the response comprises a citation disposition record.

21. The system of claim 18, wherein the citation record comprises input data.

22. The system of claim 21, wherein the input data comprises a military rank.

23. The system of claim 21, wherein the input data comprises a grade.

24. The system of claim 21, wherein the input data comprises military organization.

25. The system of claim 21, wherein the input data comprises a military installation.

26. The system of claim 21, wherein the input data comprises a serial number.

27. The system of claim 21, wherein the input data comprises an identity of a supervisor.

28. A computer usable medium having a computer readable program code embodied therein,
wherein the computer readable program code is adapted to be executed to implement the method performed by the programmed computer processor of claim 1.
